(19) United States
(12) Patent Application Publication
(10) Pub. No.: US 2025/0225457 A1
(43) Pub. Date: Jul. 10, 2025

(54) METHODS AND APPARATUS FOR OPTIMIZING FIBER DEPLOYMENT

(71) Applicant: Charter Communications Operating, LLC, St. Louis, MO (US)

(72) Inventors: Nishant Sharma, Matthews, NC (US); Joseph Orion Carden, Charlotte, NC (US)

(73) Assignee: Charter Communications Operating, LLC, Stl Louis, MO (US)

(21) Appl. No.: 18/407,846

(22) Filed: Jan. 9, 2024

(51) Int. Cl. G06Q 10/0631; G06Q 50/08

(52) U.S. Cl. CPC G06Q 10/06312; G06Q 50/08

(57) ABSTRACT

Methods and systems for optimizing optical fiber deployment are described herein. A method includes identifying, using a selection model, target buildings for deployment of optical fiber, determining neighboring buildings for each target building in a defined range using location coordinates resolution reduction, grouping each target building and associated neighboring buildings into building clusters, generating a polygon for each building cluster which connects an associated target building and associated neighboring buildings, determining whether a building cluster is optimal based on total cost for an associated polygon and a cost benefit model, iteratively performing the grouping, the generating, and a second instance of the determining after removal of one or more target buildings and associated neighboring buildings for one or more optimal building clusters and until no target buildings remain, and deploying optical fiber based on the for one or more optimal building clusters.

### TECHNICAL FIELD

This disclosure relates to deployment of optical fiber. More specifically, this disclosure relates to optimizing deployment of optical fiber to a target building and potential neighboring buildings.

### BACKGROUND

Service providers have millions of buildings with potential subscribers that do not have an optical fiber infrastructure to carry and provide services. Deployment of optical fiber generally includes construction, underground trenching, truck rolls, traffic management, permits, and other logistics. Naïve deployment of the optical fiber is inefficient and may be costly. Methods are needed which optimize optical fiber deployment.

### SUMMARY

Disclosed herein are methods and systems for optimizing deployment of optical fiber.

In some embodiments, a method for optimizing optical fiber deployment includes identifying, at a service provider system using a selection model, target buildings for deployment of optical fiber, the target buildings selected from buildings in a region, determining, by the service provider system, neighboring buildings for each target building in a defined range using location coordinates resolution reduction, grouping, by the service provider system, each target building and associated neighboring buildings into building clusters, generating, by the service provider system, a polygon for each building cluster which connects an associated target building and associated neighboring buildings, determining, by the service provider system, whether a building cluster is optimal based on total cost for an associated polygon and a cost benefit model, iteratively performing the grouping, the generating, and a second instance of the determining after removal of one or more target buildings and associated neighboring buildings for one or more optimal building clusters and until no target buildings remain, and deploying, by a service provider, optical fiber based on the for one or more optimal building clusters.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example system in accordance with some embodiments of this disclosure.

FIG. 2 is a diagram of an example region of buildings which do not have optical fiber.

FIG. 3 is a diagram of an example region of buildings where target buildings have been identified in accordance with some embodiments of this disclosure.

FIG. 4 is a diagram of an example region of buildings where a building cluster is shown for a target building in accordance with some embodiments of this disclosure.

FIG. 5 is a diagram of an example region of buildings where a polygon is shown for a building cluster in accordance with some embodiments of this disclosure.

FIG. 6 is a flowchart of an example method for optimized deployment of optical fiber in accordance with some embodiments of this disclosure.

FIG. 7 is a diagram of an example of resolution reduction in accordance with some embodiments of this disclosure.

FIG. 8 is a block diagram of an example device in accordance with some embodiments of this disclosure.

### DETAILED DESCRIPTION

Reference will now be made in greater detail to embodiments of the invention, examples of which are illustrated in the accompanying drawings. Wherever possible, the same reference numerals will be used throughout the drawings and the description to refer to the same or like parts.

As used herein, the terminology “computer”, “computing device”, or “computing platform” includes any unit, or combination of units, in a distributive platform, centralized platform, or combinations thereof, capable of performing any method, or any portion or portions thereof, disclosed herein. For example, the “computer” or “computing device” may include at least one or more processor(s).

As used herein, the terminology “processor” indicates one or more processors, such as one or more special purpose processors, one or more digital signal processors, one or more microprocessors, one or more controllers, one or more microcontrollers, one or more application processors, one or more central processing units (CPU) s, one or more graphics processing units (GPU) s, one or more digital signal processors (DSP) s, one or more application specific integrated circuits (ASIC) s, one or more application specific standard products, one or more field programmable gate arrays, any other type or combination of integrated circuits, one or more state machines, or any combination thereof.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, travel scheduling and management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is unless specified otherwise, or clear from context, “X includes A or B” is intended to indicate any of the natural inclusive permutations. That is if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, manufactures, and/or compositions of matter, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps are well known in the art, and because they do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein is a method and apparatus for optimized deployment of optical fiber in a region. In some implementations, target buildings are identified in the region based on defined criteria. To optimize the return on investment when laying optical fiber to a target building, a neighboring set of buildings is determined for each target building. That is, a determination is made as to which other buildings proximate to the target building can be included for optical fiber deployment. The neighboring set of buildings can include any of the buildings in the region. Conventionally, this may be done by computing a distance between each target building and each of the buildings in the region. This would require performing a full Cartesian join within the database storing the buildings in the region. This is computationally extensive and would take an exponentially long computational time.

In some implementations, the present method employs a geographic information based system to identify the nearest neighbors for each target building. The method uses a resolution reduction algorithm to determine neighbor buildings that are within a defined radius. The geographic information system uses a defined geographic data format to identify a location of a building. This defined geographic data format has a defined resolution based on the number of digits used to represent the location. The resolution reduction algorithm removes or truncates a defined number of least significant digits to reduce the resolution which effectively sets the defined radius and only the buildings within the defined radius remain, i.e., the neighboring set of buildings. Accordingly, a full Cartesian join is not needed.

In some implementations, an iterative clustering method is then used to identify optimal building clusters based on spend-to-cost ratios. Here, the spend is a modeled variable representing monthly recurring revenue that a service provider could ascertain from the buildings from the services based on the optical fiber deployment. The cost is a modeled variable representing the one time cost of installing the optical fiber from a splice point to the target building or the average cost from one building to it's neighbor buildings within a cluster.

For instance, in an initial iteration, a building cluster is formed for each target building by grouping together its neighboring set of buildings. A polygon is generated for each building cluster which connects together each of the buildings in the building cluster. A cost analysis is performed with respect to each polygon and the edges comprising the polygon. One or more optimal building clusters are selected. The buildings within each of the selected optimal building clusters are removed for the next iteration. The clustering, generating polygons, determining costs, selecting optimal building clusters, and removing buildings are iteratively performed until no more buildings remain. The selected optimal building clusters are further analyzed based on spend-to-cost factors and one or more optimal optical fiber deployment paths are identified.

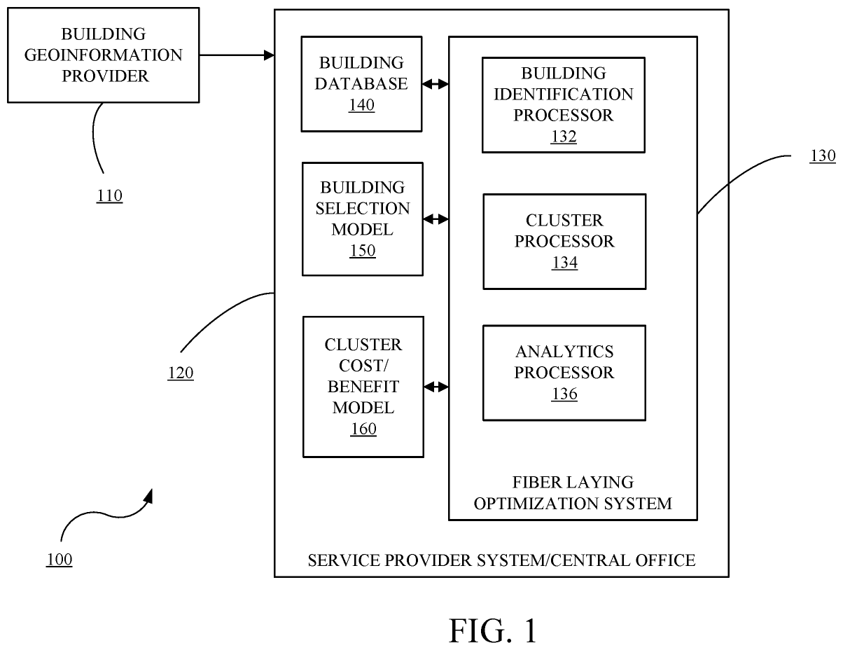

FIG. 1 is a diagram of an example system 100 in accordance with some embodiments of this disclosure. The system 1000 can include, but is not limited to, one or more building geoinformation providers 110 and a service provider system 120. The service provider system 120 can include, but is not limited to, fiber laying optimization system 130 which is connected to or in communication with (collectively “connected to”) a building database 140, a building selection model, and a cluster cost/benefit model 160. The fiber laying optimization system 130 can include, but is not limited to, a building identification processor 132, a cluster processor 134, and an analytics processor 136. In some implementations, the building identification processor 132, the cluster processor 134, and the analytics processor 136 can be one or more processors. In some implementations, the building geoinformation providers 110 and the service provider system 120 and components thereof are connected to each other via a combination of wired and/or wireless techniques, systems, and/or devices. The system 100 is illustrative and may include additional, fewer, or different components, entities and the like which may be similarly or differently architected without departing from the scope of the specification and claims herein.

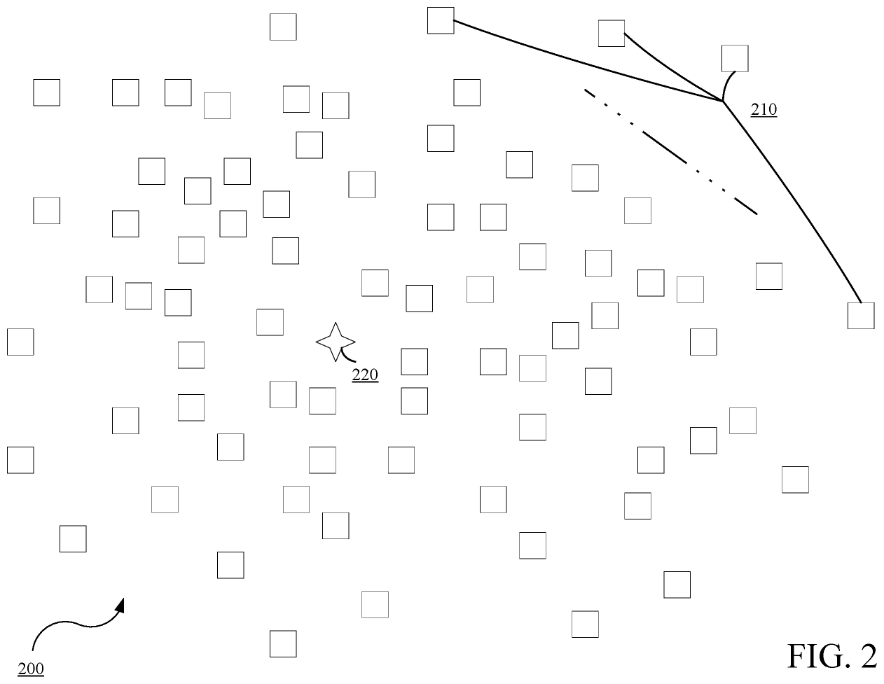

FIG. 2 is a diagram of an example region 200 of buildings 210 which do not have optical fiber. Also shown is a splice point 220. The number of buildings 210 (unfilled blocks) and the number of splice points 220 is illustrative. The building geoinformation providers 110 can provide geolocation and/or geospatial data for each of the buildings. The geolocation and/or geospatial data can be, but is not limited to, in the form of latitude and longitude coordinates. The latitude and longitude coordinates can be provided with a defined number of decimal points or bits. In some implementations, the defined number of decimal points or bits is 9 digits.

The service provider system 120 can store the geolocation and/or geospatial data in the building database 140. In some implementations, the building database 140 can be, but is not limited to, a relational database where structured query language (SQL) is used for storing and processing information in the relational database.

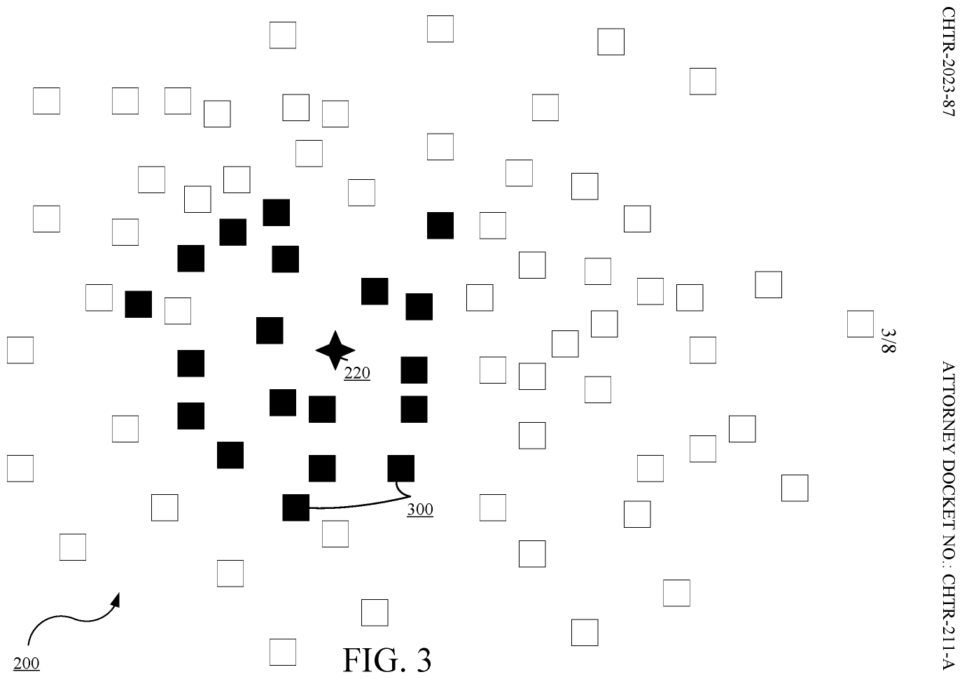

The building selection model 150 can include rules and criteria which enable the service provider system 120 and/or the building identification processor 132 to identify target buildings in a region. For example, FIG. 3 is a diagram of an example region 200 of buildings 210 where target buildings 300 (filled in black blocks) have been identified in accordance with some embodiments of this disclosure. For instance, the identification of the target buildings 300 can be based on various opportunity cost criteria. The rules and criteria can include, but is not limited to, providing each building with a unique identifier, identifying buildings occupied by enterprise tenants, identifying buildings lacking existing coaxial cable infrastructure services, identifying buildings occupied by small business tenants, identifying buildings lacking service provider fiber infrastructure, reviewing accuracy of location data of each building at the street/building level, identifying closest service provider optical fiber splice points to these buildings which are within a defined radius (e.g., splice point 220), determining whether the buildings are classified as commercial addresses, determining an estimated cost for each building (where, for a target building, cost is the estimated amount of installing optical fiber services from the closest fiber splice point to the building), identifying that buildings have tenants, assessing tenants propensity to purchase optical fiber services and the projected spending on service provider products based on statistical modeling, and other like criteria.

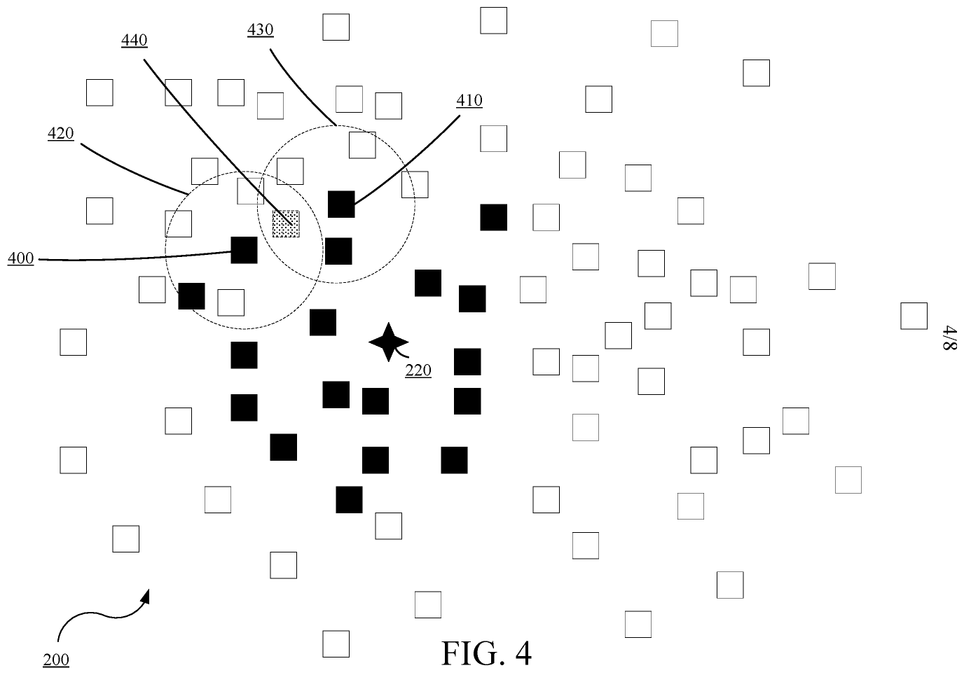

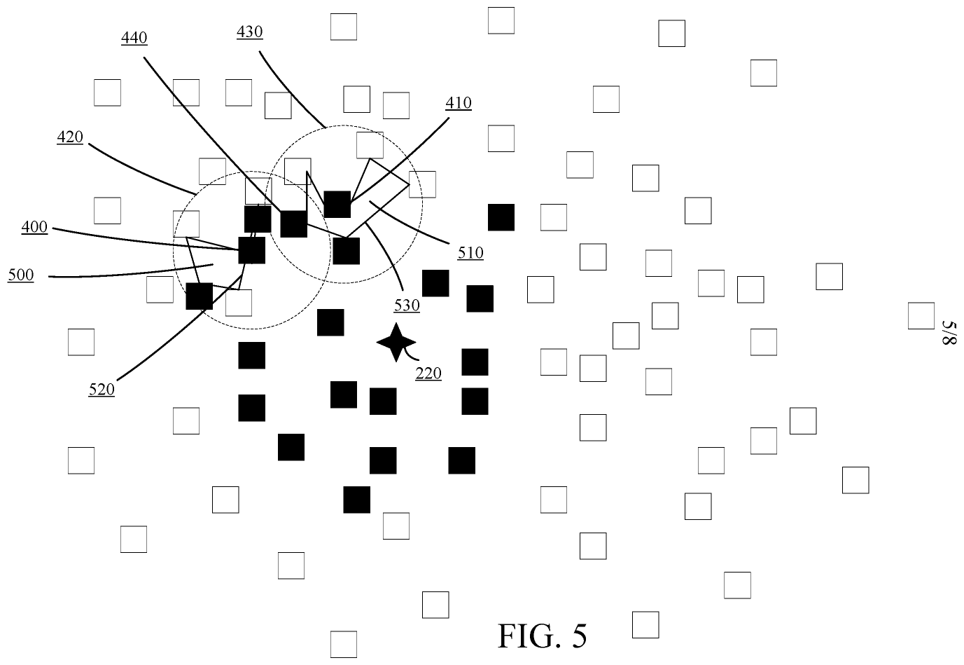

The cluster processor 134 can generate building clusters using the target buildings 300. For example, FIG. 4 is a diagram of an example region 200 of buildings 210 where target buildings 400 and 410 are shown each having a building cluster 420 and 430, respectively, in accordance with some embodiments of this disclosure. The cluster processor 134 can generate polygons for each of building clusters. For example, FIG. 5 is a diagram of an example region 200 of buildings 210 where polygons 500 and 510 are shown for the building clusters 420 and 430, respectively, in accordance with some embodiments of this disclosure. Each of the polygons 500 and 510 have edges 520 and 530, respectively. The cluster processor 134 can apply or use the building selection model 150 to each of the buildings 210 to determine optimal building clusters.

The cluster benefit or return on investment model 160 can include rules and criteria which determine the spend (profitability or revenue) to cost ratio of each building cluster. For instance, the profitability of each building cluster can be based on various spend criteria as applied to each building cluster, the generated polygon associated with each building cluster, and the one or more edges associated with each polygon to determine a spend and cost criteria as applied to the buildings in each building cluster.

The analytics processor 136 can analyze the optimal building clusters against marketing, sales, and proactive build strategies and select the optimal building clusters with the highest spend-to-cost ratio.

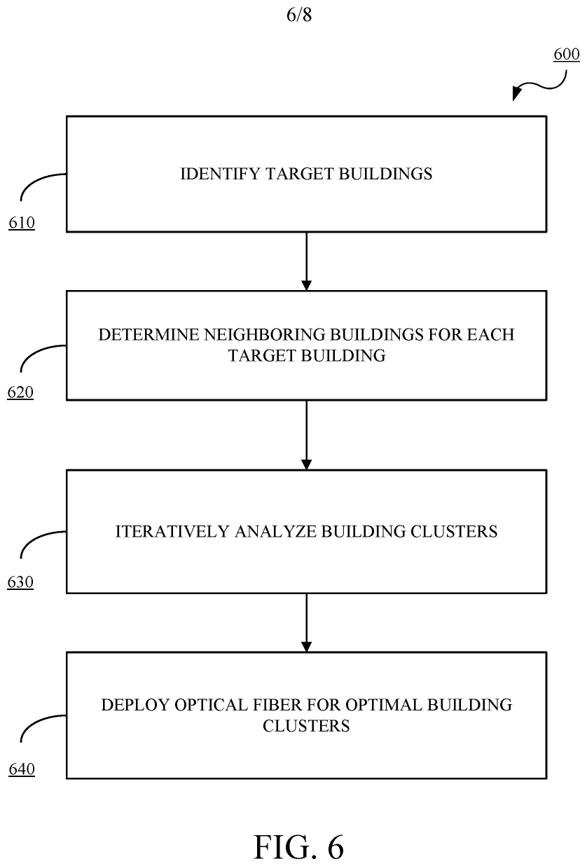

FIG. 6 is a flowchart of an example method 600 for optimized deployment of optical fiber in accordance with some embodiments of this disclosure. With reference also to FIGS. 1-5, at 610, a set of target buildings, such as the target buildings 300, are identified by the building identification processor 132 using the building selection model 150. At 620, sets of neighboring buildings are determined for each target building. The building identification processor 132 uses a resolution reduction algorithm to determine the sets of neighboring buildings relative to each target building. The resolution reduction algorithm, in effect, determines the set of neighboring buildings for a defined radius.

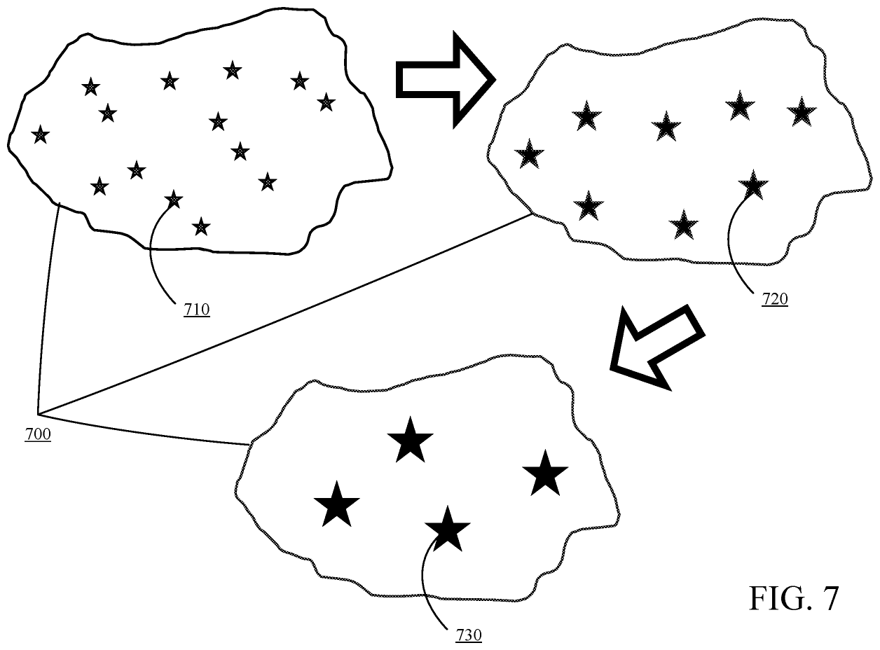

The resolution reduction algorithm is described with respect to FIG. 7. Assume that a region 700 includes a set of buildings 710. Each building has a location identified using a latitude and longitude coordinate pair. The latitude and longitude coordinate pair having a resolution defined by the number of bits used to identify the location of a building. For instance, assume the defined number of bits is 9. Truncation of the least significant bit reduces the resolution of the buildings such that the region 700 only shows the buildings 720. Truncation of a next least significant bit reduces the resolution of the buildings such that the region 700 only shows the buildings 730. Therefore, distance and neighbor building determination is simplified. The level of bit truncation effectively defines the radius for the target buildings. The resolution reduction algorithm can provide an estimation of distances between buildings without the need for a full Cartesian join. This reduces computation time with respect to processing the building data in the building database 140. In implementations, actual distances may be determined once the resolution reduction algorithm is applied for each target building. The target buildings and neighboring building information can be maintained or saved in the building database 140.

At 630, the most profitable combinations of buildings (also referred to as building clusters) are determined by the cluster processor 134 using the cluster cost/benefit model 160. The clustering is performed on an iterative basis for each target building until no more buildings are left to be analyzed. Initially, for each target building, the cluster processor 134 groups or clusters the neighboring builds for a defined radius as shown in FIG. 4. Some buildings may be in multiple building clusters. For example, building 440 is in both building cluster 420 and 430. For each building cluster, a polygon is generated which connects all the buildings in the building cluster. Example polygons are shown in FIG. 5. In some implementations, the polygons are built by connecting the target building to the neighbor building in the northmost position in the building cluster. Remaining neighbor buildings in the cluster building can be connected in a clockwise fashion until all the neighbor buildings are included in the polygon and the last neighbor building is connected to the target building. Polygons can be built using other methods without varying from the scope of the claims or specification described herein.

The average cost associated with a neighbor building in a building cluster can be estimated by using the average edge length of the polygon for the building cluster and the cost per region (where each region serviced by the service provider has a cost (e.g., construction cost) which can be an input to a model such as the cost benefit model 160). The total cost of the cluster is determined by adding the cost of the target building (e.g., estimated cost from splice point to the target building) to the estimated cost of all neighbors in the cluster. The most favorable or profitable building clusters (e.g., optimal building clusters) are identified and selected based on the spend-to-cost ratio. In implementations, the spend-to-cost ratio is compared against a threshold. Building clusters meeting or exceeding the threshold are deemed optimal building clusters. The cluster processor 134 removes the target building and the neighboring buildings associated with the selected optimal building clusters. A new set of building clusters are generated with the remaining buildings and the computations described herein are repeated. The clustering is completed when no target buildings remain. In other words, clustering is complete when there are no buildings left in a starting base, every building has either a target or neighbor definition, and that every cluster has a target. In some implementations, the entirety of the process can be repeated with a different radius for identifying neighbor buildings so as to provide greater insight as to profitable building clusters.

At 640, the selected optimal building clusters are analyzed against marketing, sales, and proactive build strategies. The building clusters with the best or highest spend-to-cost ratios can be selected for optical fiber deployment.

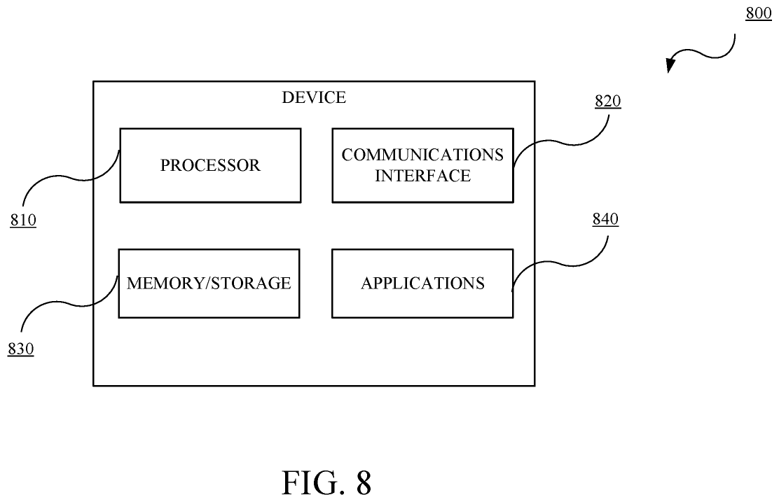

FIG. 8 is a block diagram of an example device 800 in accordance with some embodiments of this disclosure. The device 800 may include, but is not limited to, a processor 810, a memory/storage 820, a communication interface 830, and applications 840. The device 800 may include or implement, for example, the system 100, the building geoinformation provider 110, the service provider system 120, and components therein. In implementations, the memory/storage 820 may store the building information, cost information, spend information, building cluster information, model information, and the like. The techniques or methods described herein may be stored in the memory/storage 820 and executed by the processor 810 in cooperation with the memory/storage 820, the communications interface 830, and applications 840, as appropriate. The device 800 may include other elements which may be desirable or necessary to implement the devices, systems, methods described herein. However, because such elements and steps are well known in the art, and because they do not facilitate a better understanding of the disclosed embodiments, a discussion of such elements and steps may not be provided herein.

Described herein are methods and apparatus for optimizing optical fiber deployment. In some implementations, a method includes identifying, at a service provider system using a selection model, target buildings for deployment of optical fiber, the target buildings selected from buildings in a region. The service provider system may determine neighboring buildings for each target building in a defined range using location coordinates resolution reduction, group each target building and associated neighboring buildings into building clusters, generate a polygon for each building cluster which connects an associated target building and associated neighboring buildings, determine whether a building cluster is optimal based on total cost for an associated polygon and a cost benefit model, iteratively perform the grouping, the generating, and a second instance of the determining after removal of one or more target buildings and associated neighboring buildings for one or more optimal building clusters and until no target buildings remain, and deploy optical fiber based on the for one or more optimal building clusters.

In some implementations, each of the buildings has a location defined by location coordinates with a defined resolution and wherein the location coordinates resolution reduction reduces the resolution and effectively sets a radius for determining the neighboring buildings for each target. In some implementations, each of the buildings has a location defined by a latitude and longitude pair of coordinates with a defined number of decimal points and wherein the location coordinates resolution reduction truncates one or more least significant decimal points to effectively set a radius for determining the neighboring buildings for each target. In some implementations, the defined number of decimal points is nine and the one or more least significant decimal points is two. In some implementations, a building cluster can include other target buildings and non-target buildings. In some implementations, a polygon has one or more edges, and the method further includes determining an average length of the one or more edges, multiplying the average length of an edge with a cost per region to estimate a cost for a neighbor building, and determining the total cost by adding a cost of the target building and costs for each of the neighboring buildings forming the polygon. In some implementations, the method further includes comparing each total cost against a threshold to identify the one or more optimal building clusters. In some implementations, the building clusters can have overlapping buildings.

Described herein are methods and apparatus for optimizing optical fiber deployment. In some implementations, an optical fiber laying optimization system includes a memory configured to store a cost benefit model, a building database with buildings, and a processor connected to the building database and the memory. The processor and the memory implementing the cost benefit model. The processor configured to designate which of the buildings are target buildings for deployment of optical fiber, for each target building, determine a set of neighbor buildings using resolution reduction on location data for the buildings, for each target building, form a cluster including the target building and its set of neighbor buildings, for each cluster, establish a polygon which connects the target building and its set of neighbor buildings, for each iteration, find one or more clusters having optimal profitability based on associated polygon costs and the cost benefit model, repeat, until no target buildings remain, cluster formation, polygon generation, and optimal cluster determination after removal of target buildings and neighboring buildings associated with the one or more optimal clusters, and designate one or more of the optimal clusters for optical fiber deployment.

In some implementations, the memory is configured to store a building selection model and the processor is configured to designate which of the buildings are target buildings using the building selection model. In some implementations, each of the buildings has a location defined by location coordinates with a defined resolution and wherein the resolution reduction reduces the resolution of the defined resolution and effectively sets a radius for determining the set of neighbor buildings. In some implementations, each of the buildings has a location defined by a latitude and longitude pair of coordinates with a defined number of decimal points and wherein the resolution reduction truncates one or more least significant decimal points to effectively set a radius for determining the set of neighbor buildings. In some implementations, the defined number of decimal points is nine and the one or more least significant decimal points is two. In some implementations, a cluster can include other target buildings and non-target buildings. In some implementations, a polygon has one or more edges and the processor is further configured to determine an average length of the one or more edges, multiply the average length of an edge with a cost per region to estimate a cost for a neighbor building, and determining the cost by adding a target building cost and costs for all of the neighbor buildings forming the polygon. In some implementations, a polygon has one or more edges and the processor is further configured to compare each cost against a threshold to identify the one or more optimal clusters. In some implementations, the building clusters can have overlapping buildings.

Described herein are methods and apparatus for optimizing optical fiber deployment. In some implementations, a non-transitory computer storage medium storing computer-useable instructions that, when used by one or more processors, cause the one or more processors to identify target buildings for deployment of optical fiber, the target buildings selected from buildings in a region, determine neighbor buildings for each target building in a defined range using resolution reduction, form a cluster for each target building and its associated neighbor buildings, for each cluster, connect an associated target building and its associated neighbor buildings to form a polygon, select one or more optimal clusters based on an associated polygon cost and a cost benefit model, iteratively form, connect, and select, after removal of one or more target buildings and its associated neighbor buildings for the one or more optimal clusters, until no target buildings remain, and designate at least one of the one or more optimal clusters for optical fiber deployment.

In some implementations, each of the buildings has a location defined by a latitude and longitude pair of coordinates with a defined number of decimal points and wherein the resolution reduction truncates one or more least significant decimal points to effectively set a radius for determining the neighbor buildings. In some implementations, a polygon has one or more edges and further cause the one or more processors to determine an average length of the one or more edges, multiply the average length of an edge with a cost per region to estimate a cost for a neighbor building, and determine the cost by adding a target building cost and costs for all of the neighbor buildings forming the polygon.

Although some embodiments herein refer to methods, it will be appreciated by one skilled in the art that they may also be embodied as a system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more the computer readable mediums having the computer readable program code embodied thereon. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for optimizing optical fiber deployment, the method comprising:
identifying, at a service provider system using a selection model, target buildings for deployment of optical fiber, the target buildings selected from buildings in a region;
determining, by the service provider system, neighboring buildings for each target building in a defined range using location coordinates resolution reduction;
grouping, by the service provider system, each target building and associated neighboring buildings into building clusters;
generating, by the service provider system, a polygon for each building cluster which connects an associated target building and associated neighboring buildings;
determining, by the service provider system, whether a building cluster is optimal based on total cost for an associated polygon and a cost benefit model;
iteratively performing the grouping, the generating, and a second instance of the determining after removal of one or more target buildings and associated neighboring buildings for one or more optimal building clusters and until no target buildings remain; and
deploying, by a service provider, optical fiber based on the for one or more optimal building clusters.

2. The method of claim 1, wherein each of the buildings has a location defined by location coordinates with a defined resolution and wherein the location coordinates resolution reduction reduces the resolution and effectively sets a radius for determining the neighboring buildings for each target.

3. The method of claim 1, wherein each of the buildings has a location defined by a latitude and longitude pair of coordinates with a defined number of decimal points and wherein the location coordinates resolution reduction truncates one or more least significant decimal points to effectively set a radius for determining the neighboring buildings for each target.

4. The method of claim 3, wherein the defined number of decimal points is nine and the one or more least significant decimal points is two.

5. The method of claim 1, wherein a building cluster can include other target buildings and non-target buildings.

6. The method of claim 1, wherein a polygon has one or more edges, and the method further comprising:
determining an average length of the one or more edges;
multiplying the average length of an edge with a cost per region to estimate a cost for a neighbor building; and
determining the total cost by adding a cost of the target building and costs for each of the neighboring buildings forming the polygon.

7. The method of claim 1, further comprising:
comparing each total cost against a threshold to identify the one or more optimal building clusters.

8. The method of claim 1, wherein the building clusters can have overlapping buildings.

9. An optical fiber laying optimization system comprising:
a memory configured to store a cost benefit model;
a building database with buildings; and
a processor connected to the building database and the memory, the processor and the memory implementing the cost benefit model, the processor configured to:
designate which of the buildings are target buildings for deployment of optical fiber;
for each target building, determine a set of neighbor buildings using resolution reduction on location data for the buildings;
for each target building, form a cluster including the target building and its set of neighbor buildings;
for each cluster, establish a polygon which connects the target building and its set of neighbor buildings;
for each iteration, find one or more clusters having optimal profitability based on associated polygon costs and the cost benefit model;
repeat, until no target buildings remain, cluster formation, polygon generation, and optimal cluster determination after removal of target buildings and neighboring buildings associated with the one or more optimal clusters; and
designate one or more of the optimal clusters for optical fiber deployment.

10. The system of claim 9, wherein the memory is configured to store a building selection model and the processor is configured to designate which of the buildings are target buildings using the building selection model.

11. The system of claim 9, wherein each of the buildings has a location defined by location coordinates with a defined resolution and wherein the resolution reduction reduces the resolution of the defined resolution and effectively sets a radius for determining the set of neighbor buildings.

12. The system of claim 9, wherein each of the buildings has a location defined by a latitude and longitude pair of coordinates with a defined number of decimal points and wherein the resolution reduction truncates one or more least significant decimal points to effectively set a radius for determining the set of neighbor buildings.

13. The system of claim 12, wherein the defined number of decimal points is nine and the one or more least significant decimal points is two.

14. The system of claim 9, wherein a cluster can include other target buildings and non-target buildings.

15. The system of claim 9, wherein a polygon has one or more edges and the processor is further configured to:
determine an average length of the one or more edges;
multiply the average length of an edge with a cost per region to estimate a cost for a neighbor building; and
determining the cost by adding a target building cost and costs for all of the neighbor buildings forming the polygon.

16. The system of claim 15, wherein a polygon has one or more edges and the processor is further configured to:
compare each cost against a threshold to identify the one or more optimal clusters.

17. The system of claim 9, wherein the building clusters can have overlapping buildings.

18. A non-transitory computer storage medium storing computer-useable instructions that, when used by one or more processors, cause the one or more processors to:
identify target buildings for deployment of optical fiber, the target buildings selected from buildings in a region;
determine neighbor buildings for each target building in a defined range using resolution reduction;
form a cluster for each target building and its associated neighbor buildings;
for each cluster, connect an associated target building and its associated neighbor buildings to form a polygon;
select one or more optimal clusters based on an associated polygon cost and a cost benefit model;
iteratively form, connect, and select, after removal of one or more target buildings and its associated neighbor buildings for the one or more optimal clusters, until no target buildings remain; and
designate at least one of the one or more optimal clusters for optical fiber deployment.

19. The medium of claim 18, wherein each of the buildings has a location defined by a latitude and longitude pair of coordinates with a defined number of decimal points and wherein the resolution reduction truncates one or more least significant decimal points to effectively set a radius for determining the neighbor buildings.

20. The medium of claim 18, wherein a polygon has one or more edges and further cause the one or more processors to:
determine an average length of the one or more edges;
multiply the average length of an edge with a cost per region to estimate a cost for a neighbor building; and
determine the cost by adding a target building cost and costs for all of the neighbor buildings forming the polygon.
